(19) United States
(12) Patent Application Publication
(10) Pub. No.: US 2025/0099896 A1
(43) Pub. Date: Mar. 27, 2025

(54) Moisture Removal Device and Method

(71) Applicant: W.L. Gore & Associates, Inc., Newark, DE (US)

(72) Inventors: Robert B. Gifford, Newark, DE (US); Mark D. Goodrich, Newark, DE (US)

(73) Assignee: W.L. Gore & Associates, Inc., Newark, DE (US)

(21) Appl. No.: 18/728,207

(22) PCT Filed: Jan. 11, 2023
(86) PCT No.: PCT/US2023/060435

§ 371 Date: Jul. 11, 2024

Related U.S. Application Data
(60) Provisional application No. 63/299,427, filed on Jan. 14, 2022.

(51) Int. Cl. B01D 53/04; B01D 53/26

(52) U.S. Cl. CPC B01D 53/0407; B01D 53/261; B01D 2257/80

(57) ABSTRACT

Disclosed is a device for removing moisture from within an enclosure associated with a heat source. The device comprises a desiccant material in a chamber and a first port between the chamber and an outside environment outside. The device includes a second port between the chamber and the enclosure, having a first barrier extending across the second port and comprising an air-impermeable water vapour-permeable moisture transport layer and a second barrier extending across the second port. In use, water vapour within the enclosure permeates through the moisture transport layer and into the chamber, where it is adsorbed by the desiccant material. The desiccant material can be regenerated by heating the device, using the associated heat source. Pressure within the chamber promotes flow of vapour through the first port. Heat is conducted to the first barrier via the second barrier to prevent or reduce condensation.

### FIELD OF THE INVENTION

The invention relates to devices and methods for removing moisture from enclosures, in particular electrical enclosures housing electrical components such as are used in automotive applications.

### BACKGROUND TO THE INVENTION

Many items are susceptible to damage caused by excessive moisture. For instance, electrical and electronic items may be damaged or their functional life reduced by excessive moisture, or their operation may be moisture sensitive. Enclosed components that undergo thermal cycling, such as those contained in a housing, are similarly susceptible to moisture related problems.

Enclosures may be subject to thermal cycling from change in ambient conditions, or thermal cycling may occur during normal operation. For example, an enclosure may contain or be positioned proximate a heat source such as an electrical component or components, the operation of which results in thermal cycling of an enclosure. Examples of enclosures which are susceptible to undesirable moisture include, for example, automotive headlamp units, electronics contained in enclosed housings such as vehicle LIDAR sensor apparatus and other systems where on/off cycling of a heat source within an enclosure results in moisture build-up.

One approach to removing moisture from such enclosures is to provide greater airflow across, or through, an enclosure. However, when components are located in an enclosed housing it can be difficult to provide adequate airflow. Larger openings may also result in increased ingress of other undesirable contaminants to an enclosure such as dust, dirt, oil or the like.

It is also known to manage moisture in an enclosure using a drying agent or desiccant within the enclosure. However, desiccants have a limited capacity to adsorb moisture and require “regenerating” or removal of adsorbed moisture to continue functioning as a means to remove moisture in the air in an enclosure.

Removal of excess moisture within an enclosure has been achieved by way of active moisture pumps such as those disclosed in WO 2016/201045 or WO 2018/067944 of W. L. Gore & Associates, Inc. Such moisture pumps include desiccant material contained within a chamber that communicates with the enclosure and a vent valve to an outside environment. The vent valve can be opened during a regeneration event, such that the net effect of the moisture pump is to remove moisture from the enclosure. However, the cost and relative complexity of such device may not be suitable for certain applications.

U.S. Pat. No. 6,709,493 (W. L. Gore & Associates, Inc.) describes a venting device having a desiccant located within a chamber that is located within an enclosure proximate to a vehicle headlamp or other enclosed electrical apparatus that generates heat. The chamber is provided with a moisture permeable, air impermeable membrane for promoting permeation of water vapour into the chamber to be adsorbed by the desiccant. The chamber is provided with a port to the enclosure and a vent to the outside environment. Heat generated by the headlamp regenerates the desiccant and flow of air into the chamber via the port and out of the chamber via the vent results in a net flow of moisture out of the enclosure. The venting device relies on the presence of a net through flow of air out of the enclosure via the vent, which is not present in many applications.

Accordingly, there remains a need for improved to moisture reduction devices that address one or more of the foregoing problems.

### SUMMARY OF THE INVENTION

Aspects of the invention relate to a device for removing moisture from within an enclosure associated with a heat source, the device comprising:
a housing defining a chamber; and desiccant material in the chamber;
   a first part of the housing comprising a first port between the chamber and an environment outside of the housing;
   a second part of the housing comprising a second port between the chamber and an environment outside of the housing;
   the second port comprising a barrier extending across the second port and
comprising an air-impermeable water vapour-permeable moisture transport layer; wherein an outer side of the moisture transport layer is in fluid communication with the environment outside of the housing and an inner side of the moisture transport layer is in fluid communication with the chamber.

The second port is further provided with an arrangement for heating or flowing heat to the barrier, such as an outer barrier as disclosed in further detail herein.

The second port may comprise a first barrier extending across the second port and comprising an air-impermeable water vapour-permeable moisture transport layer; wherein an outer side of the moisture transport layer is in fluid communication with the environment outside of the housing and an inner side of the moisture transport layer is in fluid communication with the chamber; and a second barrier extending across the second port, wherein the second barrier is configured to conduct heat to the first barrier.

In use, the device is positioned with an enclosure with the second port in communication with an inside of the enclosure and the first port in communication with an environment outside of the enclosure. Water vapour within the enclosure permeates through the moisture transport layer and into the chamber, where it is adsorbed by the desiccant material. The desiccant material can be regenerated by heating the device, using the associated heat source. Pressure within the chamber promotes flow of vapour through the first port. Heat is conducted to the first barrier via the second barrier to prevent or reduce condensation on the inner side of the moisture transport layer that would otherwise inhibit or prevent the device from functioning, since condensed water in the chamber would not leave via the first port and would subsequently be reabsorbed by the desiccant material.

By an “air-impermeable” layer we refer in particular to a layer that inhibits mass air flow such as convective air flow. The skilled person will understand that some materials, such as polymeric materials, whilst still being considered to be air impermeable, may permit a low amount of diffusion of gaseous species therethrough over long time periods. Air-impermeable layers disclosed herein demonstrate essentially 0 litres/hour air flow when subjected to conventional air flow testing protocols at around 1 psi, or 7 kPa air pressure differential across the layer. The skilled person will understand that diffusion through the material of the air-impermeable layer of the order of 10⁻³-10⁰ ml/h or lower may occur with some materials useful as an air-impermeable water vapour-permeable moisture transport layer.

By “water vapour permeable”, by contrast, we refer to a layer that is specifically adapted to permit permeation of water vapour therethrough, at a rate of the order of at least between around 10⁰-10² mg/day/cm², at ambient conditions of 22° C. and 50% relative humidity.

The second barrier may be attached to the housing. The first barrier may be attached to the housing and/or the second barrier. The/each barrier may be attached to the housing for example around a periphery of the second port.

The first barrier may be an inner barrier, and the second barrier may be an outer barrier.

The device for removing moisture from within an enclosure associated with a heat source may comprise:
a housing defining a chamber; and desiccant material in the chamber;
a first part of the housing comprising a first port between the chamber and an environment outside of the housing;
a second part of the housing comprising a second port between the chamber and an environment outside of the housing;
the second port comprising:
   an inner barrier extending across the second port and comprising an air-impermeable water vapour-permeable moisture transport layer; wherein an outer side of the moisture transport layer is in fluid communication with the environment outside of the housing and an inner side of the moisture transport layer is in fluid communication with the chamber; and
   an outer barrier adjacent the outer side of the moisture transport layer;
wherein the inner barrier is movable under the action of pressure changes within the chamber caused by heating the device, between a first position in which the inner barrier is spaced apart from the outer barrier and a second position in which at least a part of the outer side of the inner barrier contacts the outer barrier.

The terms “inner” and “outer” are used herein in from the frame of reference of the chamber.

The first port of the first part of the housing and the second port of the second part of the housing are positioned in relation to one another such that in use with an enclosure, the first port can be placed in communication with an environment outside of the enclosure, and the second port placed in communication with an inside of the enclosure.

In use, the device is positioned with an enclosure with the second port in communication with an inside of the enclosure and the first port in communication with an environment outside of the enclosure. For example, the device may be positioned through an opening in a wall of the enclosure. Water vapour within the enclosure permeates through the moisture transport layer and into the chamber, where it is adsorbed by the desiccant material. The desiccant material can be periodically regenerated by heating the device, using the associated heat source. Water vapour desorbed from the desiccant material when the device is heated passes to the outside environment via the first port. Pressure within the chamber increases during heating and promotes flow of vapour through the first port. The increased pressure (i.e. a pressure differential between the chamber and the enclosure) also urges the inner barrier into contact with the outer barrier. Heating raises the temperature of the housing and the surface or surfaces of the outer barrier that contact the inner barrier. Condensation within the chamber is thereby prevented or reduced. In particular, heat transferred to the moisture transport barrier via the outer barrier reduces or eliminates condensation on the second side of the moisture transport barrier that would otherwise inhibit or prevent the device from functioning. In addition, when the inner barrier contacts the outer barrier, the surface area of the inner barrier in fluid communication with the enclosure is also reduced, which in turn reduces the rate of permeation of vapour from the chamber to the enclosure during the desiccant regeneration period.

The device is of simple construction and includes few moving parts, and in some embodiments just a single moving part. The device can be made cost effectively and to a compact design.

The device for removing moisture from within an enclosure associated with a heat source may comprise:
a housing defining a chamber; and desiccant material in the chamber;
   a first part of the housing comprising a first port between the chamber and an environment outside of the housing;
   a second part of the housing comprising a second port between the chamber and an environment outside of to the housing;
the second port comprising a first barrier extending across the second port and comprising an air-impermeable water vapour-permeable moisture transport layer; wherein an outer side of the moisture transport layer is in fluid communication with the environment outside of the housing and an inner side of the moisture transport layer is in fluid communication with the chamber; and a second barrier fixedly attached to the first barrier;
wherein the second barrier is configured to conduct heat to the first barrier.

The first barrier may be an inner barrier, and the second barrier may be an outer barrier (or vice versa, in some embodiments). The outer barrier may be fixedly attached to the outer side of the inner barrier and wherein fluid communication to the moisture transport layer is provided via the outer barrier.

The second barrier may comprise one or more apertures, the apertures providing fluid communication to the moisture transport layer. The second barrier may be perforated.

The second barrier may be at least partially embedded within the first barrier.

The second barrier may be in thermal contact with the housing. The second barrier may comprise a thermally conductive material, such as a metal (e.g. aluminium, copper, steel).

The first barrier may be formed from any of the materials, or by any of the methods, disclosed herein with reference to the inner barrier.

In another aspect, the invention extends to an enclosure comprising a device for removing moisture from an enclosure, the device comprising:
a housing defining a chamber, and desiccant material in the chamber;
a first part of the housing comprising a first port providing fluid communication between the chamber and an environment outside of the enclosure;
a second part of the housing comprising a second port between the chamber and the enclosure; and the second port comprising an air-impermeable water vapour-permeable moisture transport layer extending across the second port; wherein an outer side of the moisture transport layer is in fluid communication with the enclosure and inner side of the moisture transport layer is in fluid communication with the chamber;
and wherein the enclosure comprises or is associated a heat source configured to raise the temperature of the device and desorb at least a part of the adsorbed water from the desiccant material; and to raise the temperature of the inner side of the moisture transport layer, to thereby reduce or eliminate condensation in the chamber.

The heat source may also raise the temperature of the inside walls of the chamber.

The second port may comprise a first barrier extending across the second port and comprising an air-impermeable water vapour-permeable moisture transport layer; wherein an outer side of the moisture transport layer is in fluid communication with the environment outside of the housing and an inner side of the moisture transport layer is in fluid communication with the chamber; and a second barrier extending across the second port, wherein the second barrier is configured to conduct heat to the first barrier. The heater may be configured to raise the temperature of the second barrier.

The first barrier may be an inner barrier, and the second barrier may be an outer barrier.

The enclosure comprising a device for removing moisture from the enclosure may comprise a device comprising:
a housing defining a chamber, and desiccant material in the chamber;
a first part of the housing comprising a first port providing fluid communication between the chamber and an environment outside of the enclosure;
a second part of the housing comprising a second port between the chamber and the enclosure;
the second port comprising:
   an inner barrier extending across the second port and comprising an air-impermeable water vapour-permeable moisture transport layer; wherein an outer side of the moisture transport layer is in fluid communication with the enclosure and inner side of the moisture transport layer is in fluid communication with the chamber; and
   an outer barrier adjacent the outer side of the moisture transport layer;
wherein the enclosure comprises or is associated with a heat source operable to increase the temperature of the device, desorb at least some adsorbed water from the desiccant material and to cause an increase of pressure within the chamber;
wherein the inner barrier is movable under the action of pressure changes within the chamber caused by heating the device using the heat source, between a first position in which the inner barrier is spaced apart from the outer barrier and a second position in which at least a part of the outer face of the inner barrier contacts the outer barrier.

The enclosure comprising a device for removing moisture from within an enclosure associated with a heat source may comprise a device comprising:
a housing defining a chamber; and desiccant material in the chamber;
   a first part of the housing comprising a first port between the chamber and an environment outside of the enclosure;
   a second part of the housing comprising a second port between the chamber and the enclosure;
the second port comprising a first barrier extending across the second port and comprising an air-impermeable water vapour-permeable moisture transport layer; wherein an outer side of the moisture transport layer is in fluid communication with the environment outside of the housing and an inner side of the moisture transport layer is in fluid communication with the chamber; and a second barrier fixedly attached to the first barrier;
wherein the second barrier is configured to conduct heat from the heat source to the first barrier.

The device may be the device of other aspects of the invention, and may include any of the further or optional features thereof.

As used herein, the term “moisture” is intended to refer to water which is diffused or condensed, whether in liquid form or vapor form, from the ambient atmosphere.

As used herein, the term “outside environment” or “environment outside of” the chamber or enclosure refers to a volume or space outside of the chamber or enclosure, as the case may be. The outside environment may be at ambient conditions or may be perturbed in some way, for example by other mechanical or electrical apparatus (e.g. a vehicle engine).

It will be understood that the inner barrier may be moveable between a range of first and second positions. For example, depending on pressure in the chamber, a greater or lesser area of the outer face of the inner barrier, or the moisture transport layer thereof, may be moved into contact with the outer barrier, thereby defining a range of second positions. Similarly, depending on pressure in the chamber, the distance from the outer barrier and curvature of the inner barrier may vary, thereby defining a range of first positions.

At least a part of the inner barrier may be flexible. In some embodiments, the entire inner barrier is flexible. At least a part of the inner barrier may be elastically extendable. In some embodiments, the entire inner barrier is elastically extendable.

At least a part of the outer barrier may be flexible or movable, wherein any movement or flexing of the outer barrier is less than movement of the inner barrier.

For example, in some embodiments the outer barrier may flex under the action of the inner barrier, when the inner barrier moves to the second position. Such flex may for example permit the outer barrier to conform to the shape of the inner barrier and improve a contact area therebetween.

The outer barrier may be a fixed barrier.

In use, the device may be periodically heated by the heat source associated with the enclosure, so as to at least partially regenerate the desiccant material (i.e. to desorb at least some adsorbed water from the desiccant material). The heat source may be electrical apparatus in the enclosure, such as a car headlamp. An enclosure may in some circumstances be located sufficiently near to a heat source outside of the enclosure, such as a vehicle engine, exhaust, radiator or the like, for the device to be periodically heated during normal operation of the heat source.

The heat source may be present in the enclosure, such as adjacent to the device or in thermal contact with the device. The heat source may be present outside of the enclosure, in thermal contact with the device. Accordingly, the invention extends in some aspects to an apparatus (such as a vehicle or an electronic apparatus) comprising an enclosure of the aspects of the invention and a heat source adjacent to or in thermal contact with the device, the heat source being optionally inside the enclosure. The apparatus may for example be vehicle LIDAR apparatus within an enclosure, installed on a motor vehicle. The apparatus may be a vehicle lighting unit, comprising one or more light vehicle lights and associated apparatus such as transformers/drivers, within an enclosure.

The heat source may be a heat source dedicated to periodically heating the device.

The enclosure may comprise a heat source.

The device may comprise a heat source.

The device may be increased in temperature by a flow of heat conducted and/or radiated from the heat source.

Any suitable heat source may be used. The heat source is preferably configured to raise the temperature of the desiccant material to above 100° C., above 120° C., above 140° C. or above 150° C. The skilled person will understand that a particular desiccant materials will have particular desorption characteristics. The desorption of a particular desiccant material may for example occur more rapidly above a particular threshold temperature, and that the threshold temperature may differ for different desiccant materials.

The heat source may be configured to raise the temperature of the inner walls of the chamber, or the inner walls of the chamber defined by the housing or enclosure, to above 50° C., above 70° C., above 90° C. or above 100° C., during a regeneration event (i.e. when the desiccant material is raised to a temperature of above 100° C., above 120° C., above 140° C. or above 150° C.).

The heat source may be configured to raise the temperature of an inside of the chamber to above a maximum expected dew point within the chamber. The maximum expected dew point may depend on factors such as the amount of desiccant material, rate of regeneration, pressure build up in the chamber and thus size and amount of movement of the inner barrier, volume of the chamber and flow area of the first port, for example. The maximum expected dew point can be determined empirically.

The heat source may be configured to raise the temperature of the outer barrier (or at least an inner side thereof) above 50° C., above 70° C., above 90° C. or above 100° C., during a regeneration event (i.e. an event during which the desiccant material is at least partially regenerated, by desorbing at least a portion of adsorbed water therefrom).

The heat source is conveniently an electrical heater, comprising one or more heating elements that increase in temperature when an electrical current is applied.

The heat source may be self-regulating and may for example be a positive temperature coefficient (PTC) heater. As known in the art, a PTC heater has temperature-resistance characteristics that facilitate rapid initial heating, that can be configured to limit current flow as temperature approaches a desired temperature.

The heat source may be an inductive heater proximal to the device. The inductive heater may be operable to inductively heat one or more electrically conductive components of the device.

The housing may incorporate the heat source. For example, in some embodiments, the housing is of metal construction and the heat source is coupled to the housing, whereby heat generated by the heat source is conducted to the housing and conducted and/or radiated to the desiccant and fixed barrier. In some embodiments, the housing or a part thereof functions as a heat source. For example, the housing may in some embodiments be resistively or inductively heated, by application of a suitable electrical current or field.

The heat source may be located in the chamber. The heat source may be adjacent to, against, around or embedded within the desiccant material.

The heat source may be regulated by any suitable control system.

The terms “desiccants”, “desiccant material” or “drying agents” used herein are intended to refer to any material which adsorbs water vapor from the air or a carrier gas and is thereby able to reduce the moisture in the air or carrier gas in an enclosure. A desiccant material or drying agent is capable of releasing adsorbed water vapour when subjected to a regeneration event such as heating. The term carrier gas excludes water vapour, but can include gas such as nitrogen, hydrogen, helium or argon.

Any desiccant material or combination of desiccant materials may be used in connection with the devices and methods disclosed herein. Examples of desiccant materials include, but are not limited to inorganic salts including oxides such as Al₂O₃ or CaO, chlorides such as CaCl₂), CoCl₂, ZnCl₂, sulfates such as CaSO₄, MgSO₄ or Na₂SO₄, carbonates such as K₂CO₃, molecular sieves such a zeolites, aluminophosphates, metal organic frameworks or the like, activated carbon, gels or aerogels such as silica gel, clays such as bentonite. The desiccant material selection and amount of desiccant used may vary depending on a particular purpose, for example, the device, the environment to which the device is exposed, the size of the enclosure, the enclosure materials, how well an enclosure is sealed, etc. For example, an enclosure may of some materials, such as polycarbonate vehicle lamps, may be constructed from a material that permits permeation of water through the enclosure walls. Some enclosures may be made from more than one piece of material glued or sealed together, for example to seal an access panel to the enclosure. Seals (e.g. O-ring seals) or seams (such as a glued seam) may be prone to leakage. Ingress of moisture due to the material selection or leakage can also be a factor in the amount and/or type of desiccant material used. A motor vehicle head lamp unit may for example have an enclosure volume of around 12-22 litres, requiring a desiccant capacity (i.e. a mass of water that can be adsorbed) of around 500-1000 mg, and to be capable of adsorbing this amount of moisture over a time period of one day. In contrast, enclosures for vehicle sensors such as LIDAR sensors may have much lower leak rates, by virtue of metal housings, requiring desiccant capacity of around, or less than 10 mg per day.

The desiccant material may be provided in any suitable solid form, but is advantageously provided with a high specific surface area, such as in a particulate form, e.g. in the form of a powder or granules.

A particulate desiccant may be mixed with additional materials such as a binder, to maintain a bulk shape or form to the desiccant. The desiccant material may be provided on a support material, such as a high surface area oxide, or distributed within a matrix, such as a porous or permeable polymer matrix. The desiccant material may be mixed with a thermally or electrically conductive material, such as a metal powder. A thermally or electrically conductive material may promote heat transfer to the desiccant material, in conjunction with a suitable heat source, as disclosed herein.

Desiccant material may be contained within a porous or water vapour-permeable container, such as a pouch or bag (or a plurality thereof). Desiccant material may in some embodiments be contained within a water vapour permeable, water impermeable container, such as a hydrophobic porous material, e.g. ePTFE.

Desiccant material may be distributed within the chamber in any suitable manner. However, in some embodiments, a shaped form of desiccant (imposed by a desiccant container, a binder or a matrix, for example) may be placed in thermal or physical contact with an inner wall of the chamber.

One or more inner walls of the chamber may be coated with or lined with desiccant material.

Desiccant material may substantially fill the chamber (at least when the flexible barrier is in the first position). Desiccant material may have a shaped form to provide flow pathways around or past at least a part of the desiccant material, for example to provide for flow of water vapour to an outlet channel.

The second port may define a second area, wherein the inner barrier extends across the flow area. The second port may comprise an aperture in the housing.

The inner barrier extends across the second area. The inner barrier may have an area larger than the second area.

The inner barrier may define an inner surface of the chamber, such as all or a part of an inside wall of the chamber.

The moisture transport layer may extend across the second area (wherein in some embodiments some regions thereof may be impermeable, as disclosed below). The moisture transport layer may define an inner surface of the chamber, such as all or a part of an inside wall of the chamber.

In the second position, at least a part of the moisture transport layer may contact the outer barrier. In the first position, said at least a part of the moisture transport layer is spaced apart from the outer barrier.

The inner barrier may comprise one or more lower permeability regions or impermeable regions. A lower permeability region may have a lower permeability to water vapour than the moisture transport layer. An impermeable region may be substantially impermeable to air/carrier gas and water vapour.

One or more lower permeability or impermeable regions may be disposed between the inner and outer barrier. For example, a lower permeability or impermeable layer may be positioned between the inner and outer barriers. A lower permeability or impermeable layer may be spaced apart from the inner barrier, when the inner barrier is in the first position, and in contact with both the inner and outer barriers when the inner barrier is in the second position.

The or each of the lower permeability or impermeable regions may be positioned so as to contact the outer barrier and occlude a fluid pathway through or around the outer barrier to the outer surface of the moisture transport layer, when the inner barrier is in the second position. When the inner barrier is in the first position, the or each lower permeability or impermeable region is spaced apart from the outer barrier and the device comprises a fluid pathway through or around the outer barrier to the outer surface of the moisture transport layer.

The outer barrier may comprise a moisture transport layer laminated to a lower permeability or an impermeable layer, over one or more regions of the inner barrier. For example, a lower permeability region may be formed with one or more additional layers of the material of the moisture transport layer. A lower permeability or impermeable region may be formed with one or more layers of a support layer imbibed with lower permeability plastics material, or a foil.

The inner barrier may be laminated, across some or all of the area of the inner barrier.

The inner barrier may comprise a support layer. The support layer may be porous or permeable to air and water vapour. The support layer may comprise a flexible mesh, fabric, an electrospun membrane or a porous membrane.

The support layer may comprise a plastics or polymeric material. The support layer may comprise an expanded polymer membrane, such as an expanded polyethylene or fluoropolymer membrane, such as an ePTFE membrane. Expanded porous polymer membranes are known in the art, and typically comprise a porous microstructure comprising an interconnected fibrillar network. The fibrils may be interconnected by nodes.

Alternative support layers include acrylic copolymer membranes (such as membranes cast on a non-woven fabric layer, e.g. Versapor® membranes, manufactured by Pall Corporation, New York, USA) or polyvinylidene fluoride membranes (e.g. Durapore® membranes, manufactured by Millipore Sigma, Massachusetts, USA) or other microporous membrane materials known in the art.

The support layer may be a fibrillated polymer membrane prepared from a fibrillatable polymer such as a polyolefin, a fluoropolymer, a polyurethane, a polyester, a polyamide, polylactic acid or any combination thereof. Specific examples of fibrillatable polymers suitable for use as the support layer include, but are not limited to ultrahigh molecular weight polyethylene (UHMWPE) (U.S. Pat. No. 10,577,468 to Sbriglia), polylactic acid (PLLA; U.S. Pat. No. 9,732,184 to Sbriglia), copolymers of vinylidene fluoride with tetrafluoroethylene or trifluoroethylene (e.g. VDF-co-(TFE or TrFE) polymers; U.S. Pat. No. 10,266,670 to Sbriglia), poly (ethylene tetrafluoroethylene) (ETFE; U.S. Pat. No. 9,932,429 to Sbriglia), polyparaxylxylene (PPX; U.S. Pat. Appl. Publ. No. 2016-0032069 to Sbriglia), and polytetrafluoroethylene (PTFE; U.S. Pat. No. 3,315,020 to Gore; U.S. Pat. No. 3,953,566 to Gore; and U.S. Pat. No. 7,083,225 to Baille).

The support layer material may be selected to withstand the temperature and conditions encountered within an enclosure in use, or of the elevated temperature required to regenerate the desiccant, for example.

The inner barrier may be elastically extendable in one direction or two orthogonal directions. Movement between the first and second positions may accordingly be affected by elastically extending and contracting the inner barrier.

The support layer may be elastically extendable, in one direction or two orthogonal directions, and may comprise an elastic fabric or an elastic membrane.

An elastically extendable porous membrane may be manufactured by forming an expanded polymer membrane and then retracting the membrane by thermally treating or treating with a solvent.

Thermal or solvent retraction may result in a proportion, the majority or substantially all of the fibrils becoming serpentine or more serpentine in configuration (that is to say, having a curvature in two or more than two different directions), thereby conveying elastically extendable properties to the membrane. Such membranes and their method of manufacture are disclosed for example in US 2013/0183515 and US 2014/0172066 of W. L. Gore & Associates, Inc. each of which are incorporated herein in their entirety. Expanded porous polymer membranes may also be compressed or mechanically compacted, to impart elastically extendable properties. U.S. Pat. No. 5,026,513 of W. L. Gore & Associates, Inc., the contents of which are incorporated herein in their entirety, discloses a process for making rapidly recoverable PTFE. The microstructure of the porous PTFE material consists of nodes interconnected by fibrils, substantially all of the fibrils having bent or wavy appearance. The PTFE is first expanded by stretching, then manually compressed in the direction of the fibrils, and afterwards restrained in the compressed state and heated. The skilled person will understand that these methods may also be applied to other expanded polymer membranes such as, but not limited to, polyethylene membranes. EP3061598 of W. L. Gore & Associates, Inc., the contents of which are incorporated herein in their entirety, discloses another method of making elastically expandable porous membranes. An elastic substrate is expanded to a desired shape (such as a domed shape) and an expanded porous polymer membrane is releasably laminated thereto. The substrate is allowed to contract, thereby restructuring the microstructure of the porous polymer membrane.

The air-impermeable, water-vapour permeable moisture transport layer may comprise an air-impermeable, water vapour-permeable material such as a silicone material, a polyurethane material, an ionomer material, such as a perfluorosulfonic acid ionomer, a polyvinyl material, such as polyvinyl chloride, a polyamide material, e.g. nylon, or a polystyrene or styrene copolymer material, such as sulfonated poly(styrene-isobutylene-styrene).

The air-impermeable, water-vapour permeable moisture transport layer may comprise an air-impermeable, water vapour-permeable material selected from a silicone material, a polyurethane material, an ionomer material or a polyvinyl material. The air-impermeable, water-vapour permeable moisture transport layer may comprise an air-impermeable, water vapour-permeable material selected from a silicone material or a polyurethane material.

The moisture transport layer may comprise the support layer and the air-impermeable, water vapour-permeable material.

The air-impermeable, water vapour-permeable material may be provided as a layer laminated to a support layer. Alternatively, or in addition, the air-impermeable, water vapour-permeable material may at least partly penetrate the support layer.

For example, the support layer may be porous (for example a fabric, or an electrospun or expanded polymer membrane) and the air-impermeable, water vapour-permeable material may be present in at least some of the pores of the support layer. The porous support layer may be imbibed with air-impermeable, water vapour-permeable material (e.g. a suspension or solution thereof may be applied to the support layer and cured or dried). A layer of air-impermeable, water vapour-permeable material may be compressed with the porous support layer (optionally at an elevated temperature), to cause at least some of the air-impermeable, water vapour-permeable material to flow into the pores of the support layer.

Reference herein to a porous support layer in which the pores are imbibed with or otherwise filled with air-impermeable, water vapour-permeable material to render the moisture transport layer air-impermeable and water vapour-permeable, it will be understood that the underlying structure or microstructure of the support layer that gives rise to its porosity in the absence of any air-impermeable, water vapour-permeable material remains substantially unchanged, such that water molecules may diffuse or permeate through the moisture transport layer via the air-impermeable, water vapour-permeable material.

The outer barrier may be connected to (e.g. by adhesive, one or more fixings, welding or the like) or may be formed integrally with the housing.

The outer barrier may comprise a bridge over or across the vapour port, wherein one or more fluid pathways are defined around the outer barrier (for example between the outer barrier and the housing) and/or through the outer barrier. The outer barrier may comprise a plate, such as a metal plate. By “plate” we refer to a portion, typically rigid or substantially so, of the outer barrier providing a continuous or generally continuous surface. A generally continuous surface of a plate provides a corresponding continuous or generally continuous contact area with the inner barrier or moisture transport layer thereof, in the second position. When the outer barrier is at an elevated temperature in use, the heat flow to the moisture transport layer is thereby optimised. In turn, the risk of condensation on the inner surface of the moisture transport layer is reduced, that might otherwise inhibit or prevent the functioning of the device.

The plate may be generally flat. The plate may be provided with a profile to complement the shape or configuration of the moisture transport barrier, when the inner barrier is in the second position. For example, the inner barrier, or the moisture transport layer thereof, may adopt a “domed” shape when moved to the second position (e.g, wherein the inner barrier is elastically extendable). The plate may accordingly be provided with a corresponding domed or truncated domed inner surface, to improve contact with the inner barrier.

The plate may be in area smaller than the second port and connected across the second port by connecting portions, whereby one or more fluid pathways are defined around the plate and between the connecting portions. The plate may be offset from the housing and connected thereto by the connecting portions.

The outer barrier may be provided with one or more, or an array of apertures. In use, the apertures may be positioned adjacent corresponding impermeable portions of the inner barrier, as disclosed herein, whereby in use the impermeable portions may occlude the one or more apertures, when the inner barrier is in the second position.

The outer barrier may be in the form of a mesh or grate, such as a metal mesh or grate. The grate may be generally rigid, or may be flexible to some degree.

The second port may include a check valve.

The second port may include a check valve member disposed between the outer barrier and the inner barrier.

The check valve member may be operable to block or restrict fluid communication between the enclosure and the outer surface of the moisture transport layer, when the inner barrier is in the second position, and provide for fluid communication between the enclosure and the outer surface of the moisture transfer layer, when the inner barrier is in the first position.

The outer barrier may form a part of the check valve. As disclosed herein the outer barrier may include one or more apertures therethrough, or one or more spaces or gaps may extend around parts of the outer barrier. The check valve member may be operable to move to occlude and be spaced apart from said apertures or gaps.

The check valve member may be operatively coupled to the second port or the housing, for example actively hinged thereto, and be disposed between the inner and outer barriers. The check valve member may accordingly be urged against the outer barrier to occlude apertures through or gaps around the outer barrier, when the inner barrier moves to the second position, and be biased to move away from the outer barrier to open a fluid pathway to the outer surface of the moisture transport barrier, when the inner barrier moves to the first position.

The check valve member may be coupled to the inner barrier, for example to one or more regions of an outer surface thereof and be operable to be urged against the outer barrier to occlude apertures through or gaps around the outer barrier, when the inner barrier moves to the second position and to move away from the outer barrier to open a fluid pathway to the outer surface of the moisture transport barrier, when the inner barrier moves to the first position.

The check valve member may be operatively coupled to the housing or the second port via a thermomechanical actuator. A thermomechanical actuator may for example comprise a shape memory material, such as one or more components formed from a nickel-titanium alloy, configured to contract, bend or extend when the device is heated and close the check valve.

The check valve member may be electromechanically actuated. For example, the device may comprise a motor, operable to open and close the check valve. The check valve member may be magnetically actuated, and operable to open or close when a current is applied to a region of the check valve. For example, a current may be applied in use to the outer barrier, to magnetically attract the check valve member thereto and close the check valve, during a regeneration event.

The check valve member may be operable as a flapper valve, for example. The check valve member may be formed of a thermally conductive material, as disclosed herein.

The check valve may be configured as a poppet valve.

The first port may be configured to limit the mass transfer rate of water vapour into the chamber via the first port to below a mass transfer rate of water vapour into the chamber via the second port.

In use water vapour may enter the chamber via the first port via diffusion and the first port can be configured to limit the diffusion rate for example by selecting size of a first area of the pathway along or through the first port. The length of the fluid pathway through the first port may also, in some embodiments, be selected so as to limit or reduce mass transfer of water vapour into the chamber via diffusion.

The first port may take the form of a simple opening, through the housing and/or a wall of the enclosure. The first port may define, or extend to, an outlet channel. The outlet channel may comprise a convoluted pathway. A restricted or elongated flow path along an outlet channel, and/or a convoluted pathway may further reduce diffusion into the chamber whilst maintaining a compact device configuration.

In some embodiments, a convoluted outlet channel may be defined by a separation layer. A separation layer may include an open channel embossed on one face thereof, wherein the separation layer is placed against an inner wall of the chamber and the outlet channel is defined by the open channel and the inner wall. The separation layer may include an aperture to the chamber at an end of the open channel and the housing or enclosure wall may include an aperture that aligns with the other end of the open channel. In some embodiments, an embossed open channel may be provided on an outer surface of the housing, such that a closed outlet channel is defined between the housing and the enclosure when the housing is secured thereto.

The outlet channel may comprise a diffusion tube, which may be curved or convoluted.

The first port or outlet channel may extend to an outlet cavity, or more than one outlet cavities fluidly connected in series. The or each outlet cavity may have a larger flow area than the first port or outlet channel. One or more outlet cavities may further reduce flow or diffusion into the chamber via the first port.

One or more of the first port, the outlet channel and a said outlet cavity may include a vent cover. A vent cover may be provided over or across the second port or outlet channel. An outlet cavity may include a vent cover. An outlet cavity may include a vent cover over an open end or aperture of the outlet cavity.

A vent cover may be present to reduce ingress of contaminants, water and the like. The vent cover may function to limit diffusion and thus limit the mass transfer rate of water vapour into the chamber, via the first port. The vent cover may be gas-permeable (such gas including water vapour) and water-impermeable. The vent cover may comprise a film or membrane. The vent cover may comprise the same film of membrane material as the support layer disclosed herein. The vent cover may comprise an expanded polymer membrane, such as an expanded polyethylene membrane or an expanded polytetrafluoroethylene membrane (or other expanded fluoropolymer).

The vent cover may include one or more lower permeability or impermeable regions. The or each of the vent cover lower permeability or impermeable regions may be positioned so as to contact a corresponding outlet aperture of the first port, outlet channel or vent cavity, to occlude a fluid pathway through the said aperture. The vent cover may be displaceable under the action of gas flow from the chamber (caused by a pressure differential between the chamber and the outside environment) to move the lower permeability or impermeable region or regions away from each respective aperture.

The vent cover may be elastically extendable, for example in the manner disclosed herein in relation to the support layer, such that the vent cover is biased to a position in which the or each of the lower permeability or impermeable regions occlude each respective aperture.

The device may comprise more than one vent cover. For example, a vent cover may extend across more than one part of a fluid pathway defined by the first port, and optionally the outlet channel and one or more optional outlet cavities.

The first port may comprise a check valve, operable to open during heating of the device. The first port check valve may comprise a check valve member, operably coupled to first port or housing, for example via a thermomechanical actuator.

The first port may also be configured to restrict flow through the first port to facilitate increased pressure in the chamber during regeneration of the desiccant. The first port may comprise a flow area selected to limit flow through the first port and facilitate increased pressure in the chamber. The first port may comprise a flow restriction configured to limit flow through the first port and facilitate increased pressure in the chamber. For example, in some embodiments, a vent cover restricts flow through the first port.

The device may comprise more than one first port or outlet channel. The device may comprise more than one second port.

The device may comprise no ports or openings between the chamber and an environment outside of the chamber, other than the/each first port and/or second port. In particular, in use, the device may comprise no port or opening or any other means of fluid communication between the chamber and an inside of the enclosure.

The housing may have any suitable size or configuration, for a particular size of enclosure, moisture transfer rate and the like. However, the chamber defined by the housing is preferably small in comparison to the enclosure, for example having a volume of less than 10-2, less than 10-3, or less than 104 of the volume of the enclosure.

A part of the housing may comprise or be formed from a wall of the enclosure.

The housing may be coupled to, or adapted to be coupled to the enclosure. The housing may be coupled or adapted to be coupled to an inside of the enclosure. The enclosure may be provided with a wall port or aperture and the housing may in use be positioned to place the outlet conduit adjacent to the wall port or aperture. The housing may be coupled or adapted to be coupled in or through an aperture in a wall of the enclosure.

For example, in use the housing may be coupled to the enclosure by adhesive or one or more fixings. The housing may be threadably coupled to the enclosure. An aperture or port in the enclosure may for example be internally threaded and a portion of the housing may be externally threaded. In alternative embodiments there may be an interference fit between the housing and an aperture through an enclosure wall.

The housing may be sealed with the enclosure, for example by an O-ring (which may be held in compression between the housing and an enclosure wall) or an adhesive or sealant may be used.

The housing may be any suitable shape. In some embodiments the housing is generally circular in cross section.

The housing may be formed from any suitable material or materials. Advantageously the housing material(s) are selected such that the chamber inner walls can be effectively heated.

The housing may comprise or be formed from a thermally conductive material, such as a metal (aluminium, steel or the like). The housing may comprise or be formed from a thermally conductive plastics material capable of use at a required temperature for regenerating the desiccant (e.g. around or above 150° C.), such as a polysulfone, a polybutylene terephthalate (PBT) or a polyetherimide (PEI). The housing may comprise or be formed from a composite material comprising reinforcement material or filler in a matrix (such as a thermoset or thermoplastic matrix), wherein the reinforcement or filler is selected to promote thermal conductivity. For example, glass fibre or powder, or metallic powder, mesh or fabric may promote thermal conductivity. Thermally conductive coatings may also be used, such as metallised polymers (polymers with a metallic coating or paint).

The housing may comprise or be formed from an electrically conducting material or materials. An electrically conductive material or materials may be susceptible to resistive (ohmic) heating, or inductive heating. For example, a metal housing, or a housing comprising a metal mesh, filler or fabric composite may be resistively or inductively heated.

The housing may be insulated. An insulating outer housing may be provided between the housing and the enclosure.

The heat source may be positioned within the insulating outer housing.

According to a further aspect of the invention there is provided a method of removing moisture from an enclosure, the method comprising:
during a first period:
   transporting water vapour from the enclosure to a chamber via an air-impermeable, water vapour permeable moisture transport layer;
   adsorbing at least a part of the water vapour on to desiccant material in the chamber; and
during a second period:
   applying heat to:
      raise the temperature of the desiccant material and desorb at least a part of the adsorbed water from the desiccant material;
      raise the temperature of inside walls of the chamber and the moisture transport layer, to thereby reduce or eliminate condensation in the chamber; and
   passing at least some of the water vapour from the chamber to an environment outside of the enclosure.

The first period may be longer than the second period.

The second period may for example be between around 10 seconds and 60 minutes, whereas the first period may be between around 1 hour and seven days.

The second period may be between around 10 seconds and 30 minutes, between around 10 seconds and 10 minutes, between around 1 and 10 minutes, or between around 4 and 10 minutes, or around 5 to 7 minutes, or around 6 minutes.

The first period may be at least around 10 times, 50 times, 100 times or 200 times the length of the second period. The first period may be at least around 300, 400 or 500 times the length of the second period. The first period may be between around 100-600, or around 200-500, or 300-500 times the length of the second period. For example, the second period may be of the order of minutes (such as 1 to 10 minutes, or 2-8 minutes, or around 2 to 5 minutes, or around 3 minutes) and the first period may be of the order of hours, such as 10-30 hours, or 20-30 hours. In some embodiments, for example, the second period occurs once a day for between around 1 to 10 minutes, or 2-8 minutes, or around 2 to 5 minutes, or around 3 minutes.

The first period may be considered to be an adsorption period during which the desiccant material adsorbs water. The second period may be considered to comprise a regeneration period or event, wherein during at least a part of the second period water is desorbed from the desiccant material and the desiccant material is at least partially regenerated.

The method may comprise passing water vapour from the chamber to the environment outside of the enclosure via a first port. The method may comprise transporting water vapour from the enclosure to the chamber via a second port, wherein the moisture transport layer is disposed across the second port.

The method may comprise raising the temperature of the moisture transport layer by flowing heat from a second barrier to a first barrier that is attached to the second barrier and comprises the moisture transport layer.

The method may comprise raising the temperature of the moisture transport layer by moving an inner barrier that comprises the moisture transport layer into contact with an outer barrier during the second period, wherein the outer barrier, or at least an inner surface thereof contacting the inner barrier, is at a higher temperature than the inner barrier. The method may comprise raising the temperature of the moisture transport layer by moving the moisture transport layer into contact with the outer barrier during the second period.

The step of applying heat may raise the temperature of the outer barrier.

The method may comprise moving the inner barrier from a first position in which the inner barrier is spaced apart from the outer barrier, to a second position in which at least a part of an outer surface of the inner barrier contacts the outer barrier.

The method may comprise moving the moisture transport layer from a first position in which the moisture transport layer is spaced apart from the outer barrier, to a second position in which at least a part of an outer surface of the moisture transport layer contacts the outer barrier. It will be understood that moving the inner barrier results in said movement of the moisture transport layer.

The method may comprise moving the inner barrier by increasing pressure in the chamber. The step of applying heat may increase the pressure in the chamber.

The method may comprise elastically extending the inner barrier and/or moisture transport layer, when moving from the first to the second position.

The inner barrier may comprise one or more lower permeability or impermeable regions and the method may comprise blocking or restricting one or more fluid pathways from the enclosure to the moisture transport layer around or through the outer barrier using the lower permeability or impermeable regions, when the inner barrier is in the second position.

The method may comprise moving a check valve member to block or restrict one or more fluid pathways around or through the outer barrier, by moving the inner barrier from the first to the second position and/or moving the check valve member away from the inner barrier to open the one or more fluid pathways around or through the outer barrier.

The method may comprise, cooling or allowing to cool the desiccant material, inside walls of the chamber and in some embodiments the outer barrier. Cooling or allowing to cool may occur during at least a part of the first period. The method may comprise more than one first period and second period. The method may be conducted in multiple cycles of applying heat and cooling or allowing to cool.

The chamber may be defined by a housing and the method may comprise applying heat using a heat source adjacent to or incorporated with the housing.

The method may comprise applying heat using a heat source within the enclosure.

The method may comprise applying heat using a heat source within the chamber.

The heat source may be used to apply heat directly to the desiccant material. For example, heat may be applied via a heater adjacent to, against, around or embedded within the desiccant material.

The method may comprise raising the temperature of the desiccant material to above 100° C., above 120° C., above 140° C. or above 150° C. during the second period.

The method may comprise raising the temperature of the inner walls of the chamber, or the inner walls of the chamber defined by a said housing or the enclosure, to above 50° C., above 70° C., above 90° C. or above 100° C., during the second period (i.e. during a regeneration event), when the desiccant material is raised to a temperature of above 100° C., above 120° C., above 140° C. or above 150° C.

The method may comprise raising the temperature of the inner walls of the chamber to above the dew point within the chamber, during the second period. The method may comprise raising the temperature of an inside of the chamber to above a maximum expected dew point within the chamber.

The method may comprise raising the temperature of the said fixed barrier above 50° C., above 70° C., above 90° C. or above 100° C., during the second period.

The or each step of raising the temperature may comprise radiatively, conductively, inductively or convectively heating the inner walls, outer barrier or desiccant material, as the case may be.

The method may comprise applying an electrical current to the housing, or an electrically conduction portion thereof, to raise the temperature of the housing.

The method may comprise applying an electrical current to a heat source, such as a resistive or inductive heater.

The method may comprise increasing pressure in the chamber. Pressure may be increased by the step of applying heat.

The method may comprise flowing water vapour out of the chamber to an outside of the enclosure, during the second period. Flow of water vapour out of the chamber may be caused or increased by increasing pressure in the chamber (e.g. by expansion of water vapour and/or air in the chamber). Accordingly, the step of applying heat may further comprise; increasing pressure in the chamber, to cause water vapour to flow from the chamber to an environment outside of the enclosure, via a first port conduit; and/or increasing pressure in the chamber to cause the flexible barrier to move from the first position to the second position.

The method may comprise passing water vapour from the chamber to the outside environment by diffusion. The method may comprise causing or increasing such diffusion by applying heat. Diffusion may be increased by increasing the amount of water vapour (in turn by desorption from the desiccant material) and/or by increasing the thermal energy of water vapour and air in the chamber.

The method may comprise use of the enclosure or the device of any of the aspects or embodiments disclosed herein.

Further features of each aspect of the invention correspond to further features of any other aspect of the invention. For example, discussion of features of the enclosure or device disclosed herein and of their operation or use correspond to further features of the method disclosed herein. Conversely, the enclosure and device may include any features required by steps of the method disclosed herein.

### DESCRIPTION OF THE DRAWINGS

Non-limiting example embodiments will now be described with reference to the following figures in which:

FIGS. 1(a) and 1(b) show perspective exploded views of a device for removing moisture from an enclosure; FIG. 1(c) shows a perspective view of the assembled device; and FIG. 1(d) shows an alternative embodiment of region A of FIG. 1(a).

FIGS. 2-5 and 7 show schematic cross sectional views of alternative devices for removing moisture from an enclosure;

FIG. 6 shows a plan view of the separation layer of the device of FIG. 5

FIG. 8 shows desorption data for desiccant material within a vented cavity;

FIGS. 9(a)-(d) show images of test devices and enclosures and FIG. 9(e) shows dewpoint vs. time data acquired from Enclosures A and B (of FIGS. 9(c) and(d)) and laboratory baseline dewpoint vs. time data;

FIG. 10 shows data for moisture removal from controlled humidity enclosures for test devices with and without fixed barriers; and

FIG. 11 shows the moisture vapor transfer rate (MVTR) of air-impermeable films under different environmental conditions, and the ratio between MVTR under simulated adsorption and desorption conditions.

FIGS. 12(a) and 12(b) show exploded views of a still further device for removing moisture from an enclosure.

### DETAILED DESCRIPTION OF EXAMPLE EMBODIMENTS

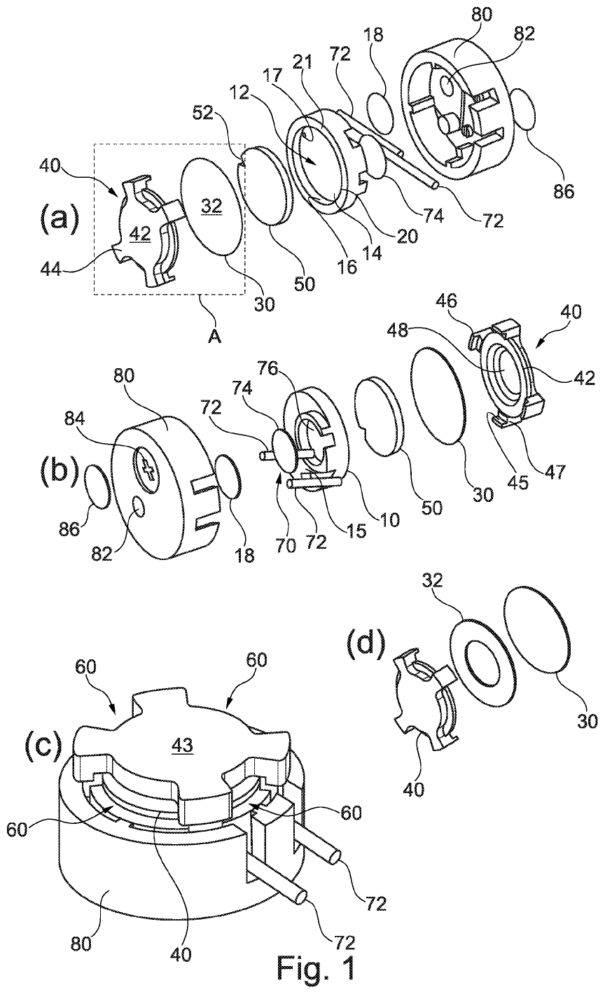

FIGS. 1(a)-(c) show a device 1 for removing moisture from an enclosure. The device includes a housing 10, defining a chamber 12. One part of the housing 10 is provided with a first port 17, in the form of an aperture extending through the housing 10 from the chamber 12 to an outside of the housing (and, in use, an outside environment). In another part of the housing, an open face of the chamber 12 defines a second port 20. The second port 20 includes an inner barrier 30 and an outer barrier 40. In the embodiment shown, the inner barrier 30 is flexible and the outer barrier 40 is fixed. A block of desiccant material 50 is positioned in the chamber. The desiccant material block 50 is sized to fit within the chamber 12 and is mounted in contact with a wall 14 thereof. The desiccant material 50 substantially fills the chamber 12 to level with or 1-2 mm below the level of the circumferential chamber wall 16.

The outer barrier 40 include a central plate 42 and connecting portions 44 by which the outer barrier is secured to the housing. In the embodiment shown, a friction fit is used, between inner sides 45 of tabs 46 extending from the connecting portions 44, but in other embodiments the outer barrier can be secured by welding or by fixings for example. In the perspective view of the assembled device of FIG. 1(c), an optional insulating cover 43 is shown clipped over the outer barrier 40.

As illustrated in FIG. 1(d), the device 1 may also optionally further include an impermeable polymer layer 36, in the form of an annular ring, disposed between the inner and outer barriers 30, 40. The layer 36 may be laminated to the inner barrier in some embodiments, so as to move together with the inner barrier between the first and second positions. Alternatively, the layer 36 may be separate from the inner barrier, such that it is spaced slightly apart therefrom when the inner barrier 30 is in the first position, and urged against and trapped between the inner and outer barriers 30, 40, when the inner barrier is in the second position.

An inside surface 48 of the plate 42 is provided with a truncated dome profile, as discussed further below. The inside surface of the plate is also spaced apart from the housing 10 (in the embodiment shown by virtue of ledges 47 on the connecting portions 44) so as to provide circumferential slots 60 between the outer barrier 40 and the housing 10.

The housing is adapted to be mounted through an aperture in an enclosure, via a flange (omitted from the figures, for clarity) with the second port 20 oriented into the enclosure. In use, the second port 20 is disposed between the enclosure (not shown) and the chamber 12.

An outer side 32 of the inner barrier 30 communicates with the enclosure. An inner side 34 of the inner barrier 30 communicates with the chamber 12. The slots 60 provide fluid pathways around the plate 42 of the outer barrier 40, between the enclosure and the inner barrier 30.

The terms “inner” and “outer” in this context are used with relation to the chamber.

The flexible inner barrier 30 consists of an air-impermeable, water-vapour permeable moisture transport layer formed from a semi-permeable ePTFE membrane imbibed with a water vapour-permeable silicone. The inner barrier 30 is fixed to the outer surface 21 of the housing 10 by adhesive, around the periphery of the vapour port 20. The moisture transport layer thereby extends across and seals around the entire flow area of the second port 20.

The ePTFE membrane of the moisture transport layer is elastic, wherein the elasticity is provided by thermal or solvent retraction, or controlled compaction as disclosed herein. The inner barrier 30 is moveable under the action of fluid pressure in the chamber 12 to cause the outer surface 32 to contact the inner surface 48 of the outer barrier 40. The elastically extendable inner barrier 30 forms a dome-like shape and the domed profile of the inner surface 48 of the outer barrier 40 increases the surface area of contact therebetween, in use (in comparison, for example, to a flat surface 48).

In the absence of any pressure differential between the chamber 12 and an enclosure, the inner barrier 30 is relatively flat and the inside surface 34 is approximately level with the outer surface 21 of the housing 10, and thus also the desiccant material 50.

In the embodiment shown, the inner barrier 30 consists of a moisture transport layer, however in alternative embodiments a moisture transport layer is secured to and forms a part of an inner barrier that includes additional components such as a structural support, or one or more lower permeability or impermeable regions; examples of which are disclosed in further detail below.

The device 1 further includes a heat source 70. The heat source includes electrical connections 72 connected via a resistive PTC heating element 74 and an intervening part of the housing 10. The heating element 74 is mounted in a recess 76 in the housing 10 and is in thermal contact therewith. When a voltage is applied between the electrical connections, current flows through the PTC heating element 74 and the housing 10 and resistively heats the device 1. As the temperature rises the resistivity of the PTC element rises and limits current flow, thereby regulating temperature to a desired approximately 155° C. maximum temperature.

The desiccant material 50 is in a shaped form that is provided with a notch 52 such that a fluid pathway to the first port 17 is always present. Mounted across the opposite end opening of the port 17 (not visible in the figures) is a vent cover 18, in the embodiment shown of ePTFE material.

The housing 10 and outer barrier 40 are of aluminium construction, to promote effective heat flow from the heat source 70 to other parts of the device 1. As disclosed herein, other materials may be used.

The device 1 further includes an optional insulating outer housing 80, formed of an insulating plastics or foam material, to assist in directing heat from the heat source 70 to the housing, outer barrier, inner barrier and desiccant material in use. The outer housing 80 is formed to fit closely around the housing 10, but to leave the outer barrier 40 and the inner barrier 30 (which are in fluid communication with the enclosure in use) exposed. The insulating outer housing 80 has an opening 82 through the housing from an inside face, adjacent the first port 17 and of larger diameter. The opening 82, together with the *of the housing 10 defines an outlet cavity that communicates with the first port 17 via the vent cover 18. Any moisture that condenses within the cavity is prevented from entering the chamber 12 by the vent cover 18. The housing optionally includes a further opening 84 therethrough, which in use functions as a passage to an enclosure to in some applications regulate pressure in the enclosure. The opening 84 has a further outer vent cover 86 across the opening 84. The vent cover 86 prevents ingress of water or particulate from the outside environment . . .

In use, the device 1 is secured through a wall of an enclosure, such as an enclosure for a vehicle LIDAR system. During a first period, water vapour from within the enclosure transports through the moisture transport layer (inner barrier 30), permeating through the air-impermeable, water vapour-permeable silicone material present in the pores of the ePTFE support layer. Water vapour entering the chamber 12 is adsorbed by the desiccant material 50. The first period can be any suitable period and may for example be of a length that humidity in the chamber 12 and within the enclosure equilibrate. In relation to any of the aspects or embodiments disclosed herein, the first period can alternatively be a shorter period, selected for example such that the overall adsorption rate of the desiccant material during the first period is higher.

During a second period, heat is applied to the device, by passing electrical current through the electrical connectors 72 and the heating element 74. Temperature of the desiccant material 50 is increased, typically above 100° C. or to around 150° C. to desorb water from the desiccant material. The inside walls of the chamber 12 defined by the aluminium housing 10 also increase in temperature, which prevents desorbed water vapour from condensing thereon.

Pressure within the chamber 12 also increases during the second period. The increased pressure creates a pressure differential between the chamber 12 and an environment outside of the enclosure, thereby promoting flow of desorbed water vapour out of the chamber 12 via the first port 17. In the embodiment shown, the vent cover 18 also limits flow out of the chamber via the first port 17, and thereby facilitates an increase in pressure in the chamber without unduly limiting the flow area of the first port 17.

The increased pressure also causes the inner barrier 30 to move from a first position in which it is generally level with the outer surface 21 of the housing 10, to a second position in which it contacts the outer barrier 40.

The outer barrier 40 is in good thermal contact with the housing 10 and is of aluminium construction. Accordingly, during heating the temperature of the fixed barrier also increases.

Accordingly, when the inner barrier 30 contacts the outer barrier 40, the temperature of the relatively poorly thermally conducting inner barrier is increased to above 100° C., or maintained above 100° C. This increased temperature prevents condensation on the inside wall 34 of the inner barrier 30 that would otherwise also not be able flow out of the first port 17. Any such condensate would remain in the chamber and then be reabsorbed by the desiccant and inhibit function of the device.

The inner barrier 30 elastically deforms and so tends to a domed shape. The internal surface 48 of the outer barrier is a truncated domed shape, and the concave regions provide for an increased surface area of contact between the inner barrier 30 and the outer barrier 40.

When the inner barrier 30 contacts the outer barrier 40 in the second position in this way, the surface area of the inner barrier 40 in communication with the enclosure is also reduced, which in turn reduces the rate of permeation of vapour from the chamber 12 to the enclosure during the desiccant regeneration period.

In the second position of the inner barrier 30 of the embodiment shown in FIG. 1(d), the impermeable layer 36 further reduces or blocks the fluid communication between the enclosure and the outer surface 32 of the inner barrier 30, via the circumferential slots 60.

The device 1 can be used in cycles, either at regular intervals or when moisture is detected in the enclosure. During a further period, the heat source 70 is switched off and the device 1 is allowed to cool. Permeation through the inner barrier 30 again occurs and the desiccant material 50 adsorbs water vapour entering the chamber, before another heating and desiccant regeneration event is initiated.

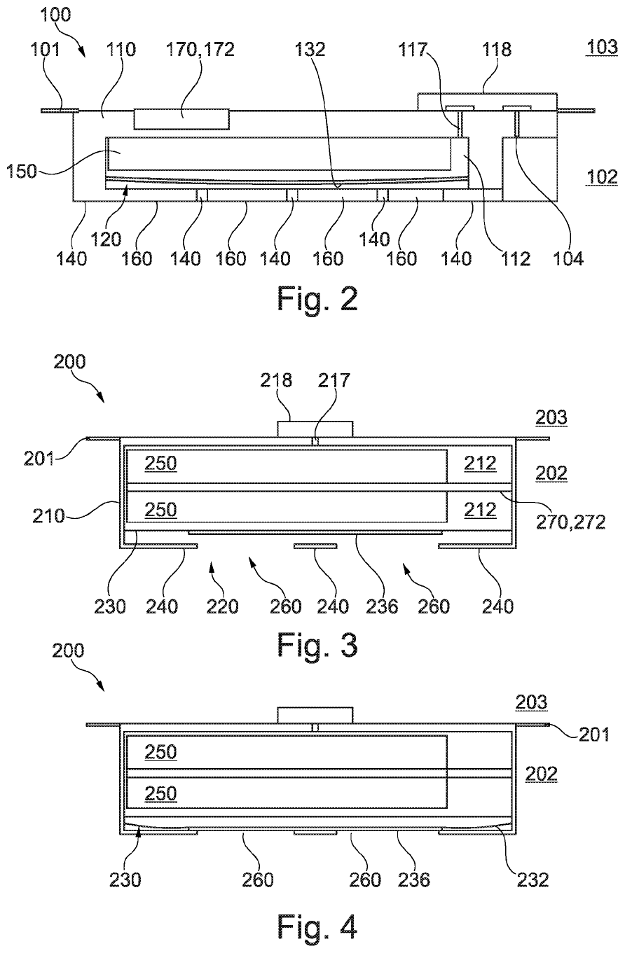

FIGS. 2-7 and 12 show further embodiments of a device for removing moisture from an enclosure.

The device 100 of FIG. 2 has a housing 110, and a chamber 112. The device 100 is mounted through an aperture in a wall 101 of an enclosure 102. A block of desiccant material 150 is positioned in the chamber 112. An electric heater 170 is mounted to the housing 110. A first port 117 extends from the chamber 112 to an environment 103 outside of the enclosure 102. The enclosure is also provided with an optional vent passage 104, which may be required in some applications for example to regulate pressure in the enclosure. The first port 117 and vent passage 104 are covered by a vent cover 118. A flexible inner barrier 130 is sealed to the housing 110 across the flow area of the vapour port (indicated generally as 120), as discussed above with reference to the device 1. The device 110 includes a fixed outer barrier 140 that is provided with perforations or apertures 160 therethrough, which provide a fluid pathway through the outer barrier 140 to the outer surface 132 of the inner barrier 130.

FIG. 3 shows a further example of a device 200 for removing moisture from an enclosure 202. The device 200 has a housing 210, defining a chamber 212. The device 200 is mounted through an aperture in a wall 201 of the enclosure 202. A block of desiccant material 250 is positioned in the chamber 212. An electric heating element 272 of a heat source (indicated generally as 270) is mounted to the housing 210 and extends into the chamber 212. The heating element 272 is embedded within the desiccant material block 250.

A first port 217 extends from the chamber 212 to an environment 203 outside of the enclosure 202, and is provided with a vent cover 218. A flexible inner barrier 230 is sealed to the housing 210 across the flow area of a second port (indicated generally as 220), as discussed above with reference to the device 1. The device 200 includes a fixed outer barrier 240 that is provided with perforations or apertures 260 therethrough, which provide a fluid pathway through the outer barrier 240 to the outer surface 232 of the inner barrier 230.

The inner barrier 230 includes a moisture transport layer 230, a central portion of which is laminated to a lower permeability polymer layer 236. In other embodiments, a foil can be used, or alternatively one or more additional layers of the air-impermeable, water-permeable material. In the first position shown in FIG. 2, the inner barrier 230 is spaced apart from the outer barrier 240. When the desiccant material 250 has been heated and pressure in the chamber 212 has increased (shown in FIG. 4), the inner barrier 230 has moved to a second position in which the lower permeability or impermeable region 236 contacts the outer barrier 240 and occludes the apertures 260. This closes or restricts the fluid pathway through the outer barrier 240 to the outer surfaces 232 of the moisture transport layer 230. In this way, permeation of vapour from the chamber 212 to the enclosure 202 during the second, heating and desiccant regeneration period is reduced.

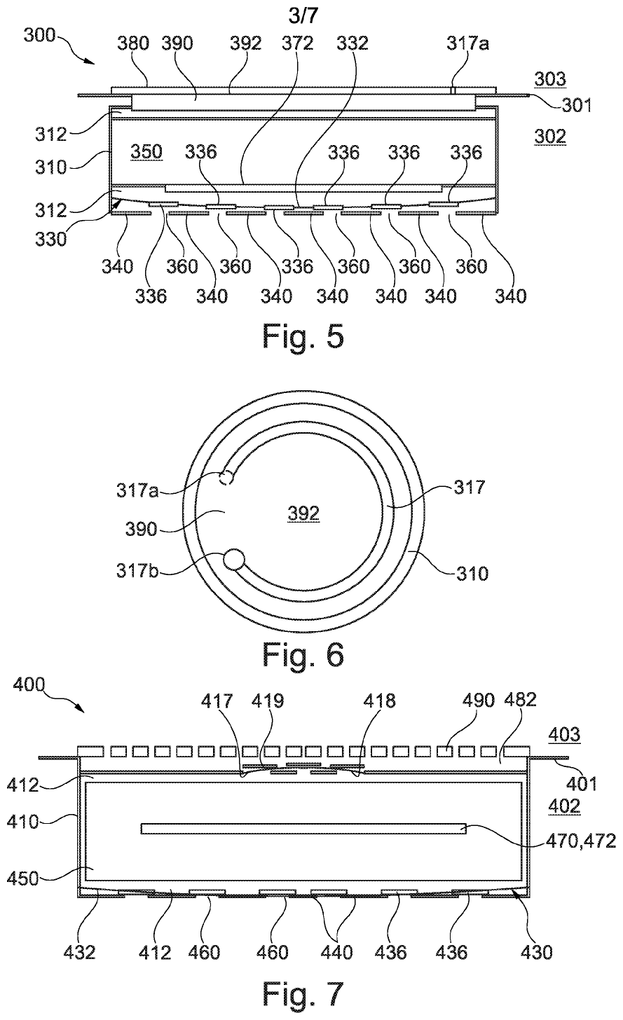

FIG. 5 shows another device 300 for removing moisture from an enclosure 302. The device is mounted through an aperture in the enclosure wall 301, as previously described. The device 300 has a housing 310, defining a chamber 312. A block of desiccant material 350 is positioned in the chamber 312. An electric heating element 372 of a heat source is positioned against the desiccant material 350. Electrical connectors are omitted from the figure, for clarity. An insulation layer 380 is positioned across the outer face of the device 300 that faces the outside environment 303.

The device 300 includes a convoluted outlet channel 317, defined by a separation layer 390 and an inner surface 312a of the cavity 312. An aperture 317a aligned with an end of the channel 317 is provided through the housing 310 and the insulation 380 to the outside environment 303. A plan view of the separation layer 390 is shown in FIG. 6, showing the channel 317 embossed into the surface 392 of the separation layer 390. One end of the embossed channel 317 extends from an aperture 317b through the separation layer, providing communication with the chamber 312. The opposite end of the channel 317 aligns with the aperture 317a.

The device 300 includes a fixed outer barrier 340 that is provided with perforations or apertures 360 therethrough, which provide a fluid pathway through the outer barrier 340 to the outer surface 332 of the inner barrier 330.

FIG. 7 shows another device 400 for removing moisture from an enclosure 402. The device is mounted through an aperture in the enclosure wall 401, as previously described. The device 400 has a housing 410, defining a chamber 412. A block of desiccant material 450 is positioned in the chamber 412, and an electric heating element 472 of a heat source is embedded therein. Electrical connectors are omitted from the figure, for clarity. The device 400 includes a flexible inner barrier 430 and a fixed outer barrier 440 that is provided with perforations or apertures 460 therethrough. The apertures 460 provide a fluid pathway through the outer barrier 440 to the outer surface 432 of the inner barrier 430 when the inner barrier 430 is in a first position, and lower permeability or impermeable regions 436 occlude the apertures 460 as previously described.

The device 400 includes multiple first ports 417, defined by apertures through the housing 410. An elastically extendable vent cover 418 of ePTFE (formed by any of the methods disclosed herein) is provided with lower permeability or impermeable regions 419. The regions 419 are positioned to cover the ports 417 in the housing, when the chamber 412 is at or around ambient pressure of the outside environment 403 and the vent cover 418 is not elastically extended. Diffusion of water vapour from the outside environment 403 into the chamber 412 is thereby reduced. The vent cover 418 is extendable to move away from the ports 417 when pressure in the chamber increases (as when the desiccant 450 is heated and the flexible barrier is in the second position as shown in FIG. 7), permitting flow of water vapour out of the chamber 412 while the device is heated. An outlet cavity 482 is defined between the housing 410 and an insulated, perforated layer 490.

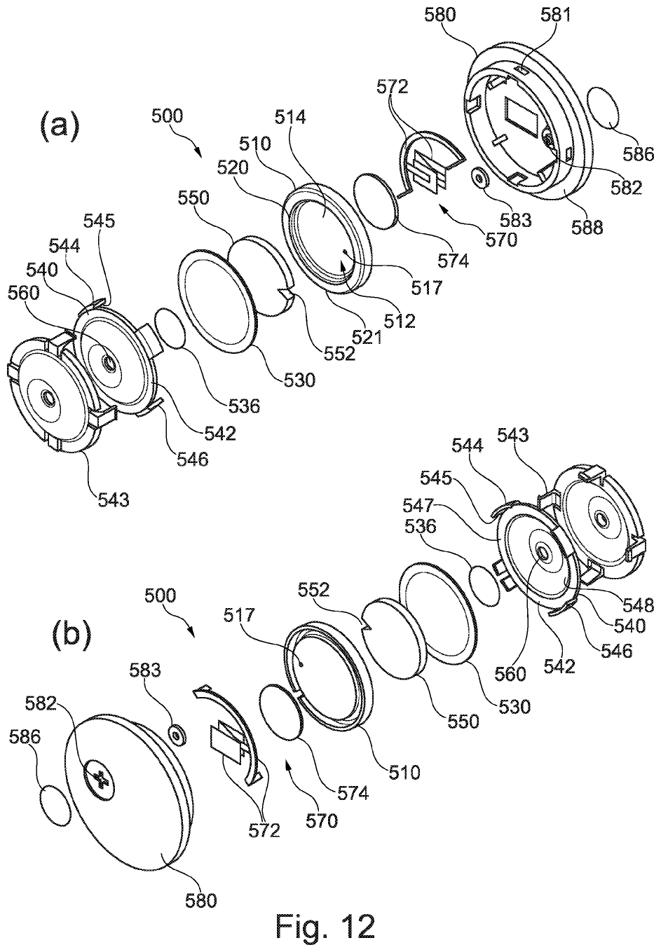

FIGS. 12(a) and 12(b) show another device 500 for removing moisture from an enclosure. Features in common with the device 1 are provided with like reference numerals, incremented by 500.

The device 500 includes a housing 510, defining a chamber 512. One part of the housing 510 is provided with a first port 517, in the form of an aperture extending through the housing 510 from the chamber 512 to an outside of the housing (and, in use, an outside environment). In another part of the housing, an open face of the chamber 512 defines a second port 520. The second port 520 includes an inner barrier 530 and an outer barrier 540. An optional insulating cover 543 may also be provided.

The inner barrier 530 is flexible and the outer barrier 540 is fixed. A block of desiccant material 550 is positioned in the chamber and is sized to fit within and substantially fill the chamber 512 and be mounted in contact with a wall 514 thereof.

The outer barrier 540 includes a central plate 542 and connecting portions 544 by which the outer barrier is secured to an insulating outer housing 580. The connecting portions 544 have inward projections 545 at the ends of projecting tabs 546 which engage and “snap fit” into slots 581 in the outer housing. When assembled, the inner annular surface 547 of the outer barrier 540 abuts with the annular outer surface 521 of the housing 510, with the inner barrier 530 therebetween, and the housing 510 is thereby mounted between the outer barrier 540 and the outer housing 580.

The housing 510 is adapted to be mounted through an aperture in an enclosure, via a flange 588 with the second port 520 oriented into the enclosure. In use, the second port 520 is disposed between the enclosure (not shown) and the chamber 512.

The device lacks circumferential slots between the housing and outer barrier of the device 1 discussed above. Instead, the outer barrier 540 is provided with a central aperture 560, which provides a fluid pathway through the central plate 542 of the outer barrier 540, between the enclosure and the inner barrier 530.

The terms “inner” and “outer” in this context are used with relation to the chamber.

The inner barrier 530 also further includes an impermeable region, in the form of a polymer layer 536 laminated to the outer surface 532, and aligned with the aperture 560. The layer 536 is urged against the outer barrier 540, when the inner barrier 530 is in the second position, and covers the aperture 560.

In common with the device 1, of the device 500, an inside surface 548 of the plate 542 is provided with a domed profile, with the aperture 560 being provided in an inwardly extending region of the dome. The optional insulating cover 543 is similarly configured.

The flexible inner barrier 530 similarly includes an air-impermeable, water-vapour permeable moisture transport layer formed from a semi-permeable ePTFE membrane imbibed with a water vapour-permeable silicone. The inner barrier 530 is fixed to the annular outer surface 521 of the housing 510 by adhesive. The moisture transport layer thereby extends across and seals around the entire flow area of the second port 520.

In the absence of any pressure differential between the chamber 512 and an enclosure, the inner barrier 530 is relatively flat. In use, when pressure in the chamber 520 increases, the inner barrier 530 elastically deforms into a dome-like shape and engages with the domed profile of the inner surface 548 of the outer barrier 540, in the second position.

The device 500 further includes a heat source 570, comprising electrical connections 572 and a resistive PTC heating element 574, which are mounted between the housing 510 and the outer housing 580, in thermal contact with the housing 510. The PTC heating element 574 is operable to resistively heat the device 500.

The desiccant material 550 is in a shaped form that is provided with a notch 552 that provides a fluid pathway to the first port 517. An O-ring 583 is positioned and seals between the port 517 and an opening 582 through the outer housing 580, and a vent cover 586 is positioned across the external face of the opening 582.

In common with embodiments disclosed herein, the housing 510 and outer barrier 540 are of metal, typically aluminium, construction, to promote effective heat flow from the heat source 570.

In use of the device 500, during a first period, water vapour from within the enclosure transports through the moisture transport layer (inner barrier 530), permeating through the air-impermeable, water vapour-permeable silicone material present in the pores of the ePTFE support layer thereof. Water vapour entering the chamber 512 is adsorbed by the desiccant material 550. During a second period, heat is applied to the device, by passing electrical current through the electrical connectors 572 and the heating element 574, to desorb water from the desiccant material. Pressure within the chamber 512 increases during the second period. The resultant increased pressure in the chamber 512 promotes flow of desorbed water vapour out of the chamber 512 via the first port 517. The increased pressure also causes the inner barrier 530 to move from a first position in which it is generally level with the outer surface 521 of the housing 510, to a second position in which it contacts the outer barrier 540. In the second position, the impermeable region 536 covers the aperture 560 and substantially blocks fluid communication between the enclosure and the air-impermeable, water vapour-permeable silicone material.

The outer barrier 540 is in good thermal contact with the housing 510 and therefore also increases in temperature during heating, to prevent condensation on the inside wall 534 of the inner barrier 530 that would otherwise occur.

It will be understood that the various examples shown in FIGS. 1-7 and 12 are illustrative devices in accordance with the invention may include additional or alternative features disclosed herein. For example, the first port configurations, outlet channel configurations, heat source configurations and second port configurations are interchangeable with one another.

### EXPERIMENTAL

### Example 1

To demonstrate proof of concept of the desorption or regeneration period of a device for removing moisture from an enclosure, an aluminium housing was provided having a chamber of approximate dimension 19 mm diameter×2.5 mm depth. A PTC heater (155° C.) was secured to the outside wall of the housing with electrically and thermally conductive epoxy. The outside wall of the housing was also provided with a 1 mm diameter outlet channel, of length 3-4 mm. A 5.5 mm ID ePTFE membrane vent was placed over the exit of the outlet channel.

A Gore silica gel desiccant material block 19 mm diameter by 2 mm thickness was placed in the chamber and adhered to the chamber wall with adhesive. The open face of the chamber was sealed with an aluminium plate, with a silicone pressure sensitive adhesive.

The housing was heated for a defined period using the PTC heater and the mass of the device was measured. The experiment was repeated for defined periods of 3, 5, 15 and 30 minutes.

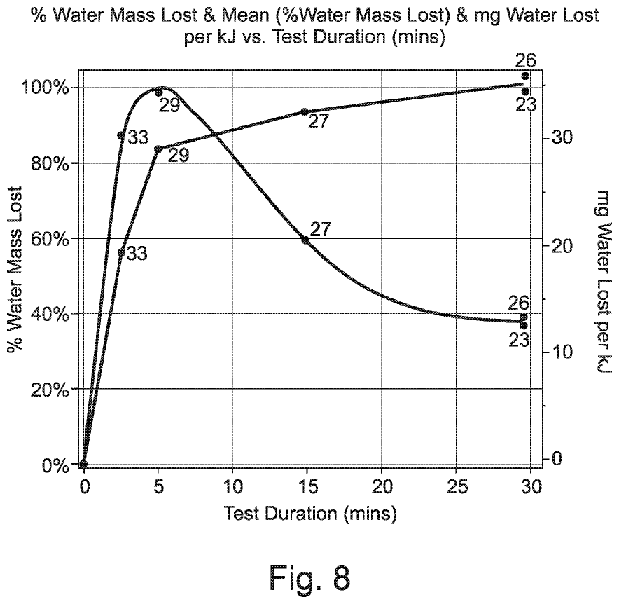

FIG. 8 shows results of changes in mass and energy usage of the heater per mg of mass change. The changes of mass are normalised between 0% and 100% of adsorbed water, corresponding to the initial and maximum mass of the device and the final equilibrium mass, which was achieved after approximately 30 minutes. Mass loss per kJ of electrical heating peaked at around 5 minutes.

These data indicate that water vapour can be effectively and rapidly desorbed from a hydrated desiccant in an enclosed chamber via an outlet channel and the vent cover, by heating the housing.

### Materials

(1) ePTFE/Silicone Material 1

An expanded polytetrafluoroethylene (ePTFE) membrane was made generally in accordance with the teachings of U.S. Pat. No. 3,953,566 (the contents of which are incorporated herein in their entirety). The ePTFE membrane had an average mass/area of 0.5 g/m² and an average thickness of less than 1 μm. The ePTFE membrane was compacted in both, the transverse direction (TD) and machine direction (MD) as is taught in Example 4A of EP3061598 A1 to Zaggl et al., by releasably laminating an ePTFE membrane to an elastically extended in a domed configuration. The substrate was relaxed to a planar configuration and the contracted ePTFE membrane removed. The processing ratio for both were 50% at room temperature (approximately 20° C.) and 2 m/min speed setting.

The compacted porous ePTFE membrane was positioned on a polyethylene terephthalate (PET) release layer (Janus® PET1120).

The ePTFE membrane/release layer stack was placed on a glass plate which was then inserted into an automatic film applicator (model ZAA 2300, Zehntner GmbH Testing Instruments, Sissach, Switzerland).

An elastomer was obtained by providing a pourable, addition-curing, two-component silicone rubber (ELASTOSIL® LR6320F, (Wacker Chemie AG, Munich, Germany) and Crosslinker SX) and mixing components LR6320F and crosslinker SX in a ratio of 10:1 using a SPEEDMIXER™ DAC 150.1 FVZ-K (FlackTek Inc., Landrum, SC) at 1500 rpm and 20 seconds mixing time.

The mixed components were poured onto the compacted porous ePTFE membrane sitting on the PET release liner. A universal applicator, type ZUA 2000 (Zehntner GmbH Testing Instruments) was used to equally distribute a thin elastomer film on the ePTFE membrane using a speed of 5 mm/s at 20° C.

The gap of the applicator was set to a 40 μm distance from the PET release layer. The elastomer film was cured at 160° C. for 5 min in an oven.

(2) ePTFE/Silicone Material 2

An expanded polytetrafluoroethylene (ePTFE) membrane was made generally in accordance with the teachings of U.S. Pat. No. 3,953,566. The ePTFE membrane had an average thickness of approximately 1 μm.

The membrane film was thread-up in a continuous process, first through a rubber and chrome nip roller with 90 psi pressure applied between them at approximately 2.4 m/min. Second, the membrane was passed through two sequential 4 ft infrared ovens (55 Amps) resulting in an approximately 160 C membrane temperature.

Dow SYLGARD™ 184, a transparent two-part polydimethylsiloxane elastomer encapsulant (10 to 1 mix ratio), was manually mixed in a jar and poured between the rubber and chrome nip rollers.

The finished film was wound on a plastic core as it exited the oven.

(3) ePE/Polyurethane

A porous polyethylene membrane was produced in accordance with the teaching of U.S. Pat. Nos. 5,248,461, 4,873,034, 5,051,183 and 6,566,012 (each of which are incorporated herein by reference) by mixing a polyethene material with a hydrocarbon liquid and other additives. The mixture was extruded into a sheet and biaxially expanded and the hydrocarbon liquid extracted.

The resulting expanded polyethylene membrane was then imbibed with a polyurethane elastomer material, in the manner described above for the ePTFE/silicone material 2.

### Example 2

Two test devices were prepared analogous to the device of Example 1. In place of the aluminium plate, each housing was sealed with an air-impermeable, water vapour-permeable layer, of the ePTFE/silicone material 2.

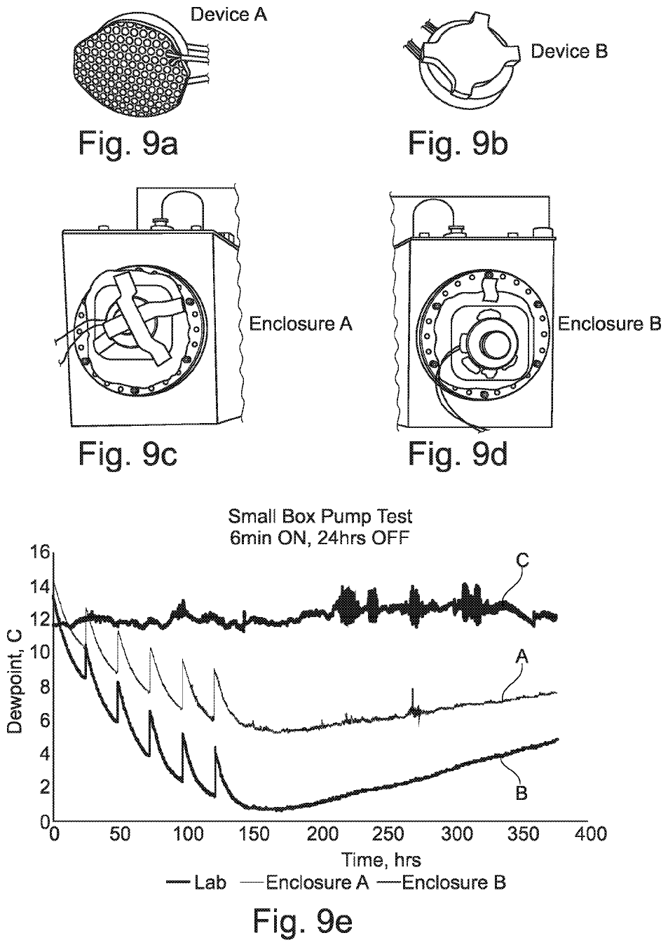

Device A was then provided with a fixed, perforated aluminium outer barrier spaced apart from the air-impermeable, water vapour-permeable layer attached across the housing, as shown in FIG. 9(a), with an approximately 0.3 mm gap therebetween. Device B was provided with an outer barrier configured as a flat plate, with connecting portions attached to the housing, as shown in FIG. 9(b), with an approximately 1 mm gap therebetween.

Each device was secured through an aperture in a 12 L capacity enclosure. Each enclosure was provided with a 1 mm diameter, 3 mm long aluminium diffusion tube outlet for pressure equalisation, but was otherwise sealed. An ePTFE vent cover was positioned over the diffusion tube outlet. The outlet channel and vent port facing of each device was positioned to communicate with the external environment, and the fixed barrier and flexible barrier (the air-impermeable, water vapour-permeable layer) was positioned inside the enclosure A and enclosure B respectively. External to each enclosure, the exposed parts of each device housing was covered by hand cut foam insulation (FIGS. 9(c) and 9(d)).

Each enclosure was fitted with capacitive temperature and humidity sensors (Ahlborn FHA646-R).

The devices A and B were then subject to six 6 minute heat cycles, separated by 24 hour periods and dew point within the enclosures monitored throughout. Results are shown in FIG. 9(e). Line A shows dew point within enclosure A. Line B shows dew point in enclosure B. Line C shows dew point in the laboratory setting, which remained generally constant throughout. Temperature in the laboratory was also measured as being generally constant throughout the entire test period, and varied between a low of around 21.1° C. and a high of around 22.3° C.

These data illustrate that devices A and B are each capable of removing moisture from the enclosures A and B, by repeated cycles of heating.

During each heating cycle, a temporary increase in the dew point occurred, consistent with permeation of water vapour desorbed from desiccant within the chamber of each device A and B into the respective enclosure via the moisture transport layer. During each intervening period, dew point was observed to drop, consistent with permeation of water vapour out of each enclosure via the moisture transport layer. The gradual decrease of dewpoint within each of the enclosures between successive heat cycles indicates that desorbed water vapour exiting via the outlet channels of each of the devices A and B exceeds the back-permeation into the respective enclosures.

Data for enclosure B shows a greater overall decrease in dew point than for enclosure A. This observation demonstrates a greater surface area of contact between the fixed barrier of enclosure B and the moisture transport layer, than is the case for enclosure A.

Following the final heating cycle, dew point was monitored for a further 7 days. For approximately 36 hours dewpoint within each enclosure A and B dropped. Thereafter the dew point gradually rose, consistent with full hydration of the desiccant within each device A and B, followed by diffusion of water vapour into each enclosure via the outlet channel and moisture transport barrier. This process was shown to be considerably slower than the rate of moisture pumping out of each enclosure during the preceding six heat/adsorb cycles.

### Example 3

Experiments were conducted to demonstrate the use of the device B to pump from an enclosure held at a relative humidity above an external humidity (“downhill pumping”) and from an enclosure held at a relative humidity below an external humidity laboratory (“uphill pumping”). The experimental protocols correspond general to those disclosed in WO2021118558 (W. L. Gore & Associates, Inc.), the contents of which are incorporated herein by reference.

In some experiments, Device B was equipped with an ePTFE/silicone material 1 inner barrier. In some experiments, Device B was equipped with the ePTFE/silicone material 2 inner barrier.

Device B was installed in a 50 L sealed enclosure, generally as described for Example 2 above. A balance with data logging capability was placed inside the enclosure. The enclosure was placed inside a temperature and humidity controlled environmental chamber held at 50% RH and 30° C. A second humidity-temperature probe was located inside the environmental chamber to monitor the chamber conditions.

All of the access panels of the enclosure were opened so the inside of the enclosure was exposed to the chamber environment.

The temperature-humidity probes within the enclosure and environmental chamber and the balance were connected to a data logger and data logging was started. The enclosure and the balance were allowed to equilibrate for 67 hours.

A 14 cm diameter petri-dish holding a supersaturated salt bath (magnesium chloride hexahydrate) was placed on the balance. The supersaturated salt solution was provided in a sufficient amount so as to maintain an approximately 35% relative humidity at 35° C. within the enclosure. All the enclosure access panels of the enclosure were closed creating a sealed environment. The enclosure with the balance and supersaturated salt solution was allowed to equilibrate for a further 70 hours, with data logging from the temperature-humidity probes and balance maintained throughout.

The device B was then heated for 6 minutes to 155° C., allowed to cool for 23 hours 54 minutes, and this cycle repeated 5 times.

The experiment was repeated with the supersaturated salt bath selected for a relative humidity in the enclosure of 56% (using a magnesium nitrate hexahydrate salt bath) and again at 83% (using a sodium chloride salt bath).

The device B was then uninstalled from the enclosure and a device lacking the fixed barrier was installed, and having the ePTFE/silicone membranes only across the second port. The “uphill” and “downhill” experiments were then repeated.

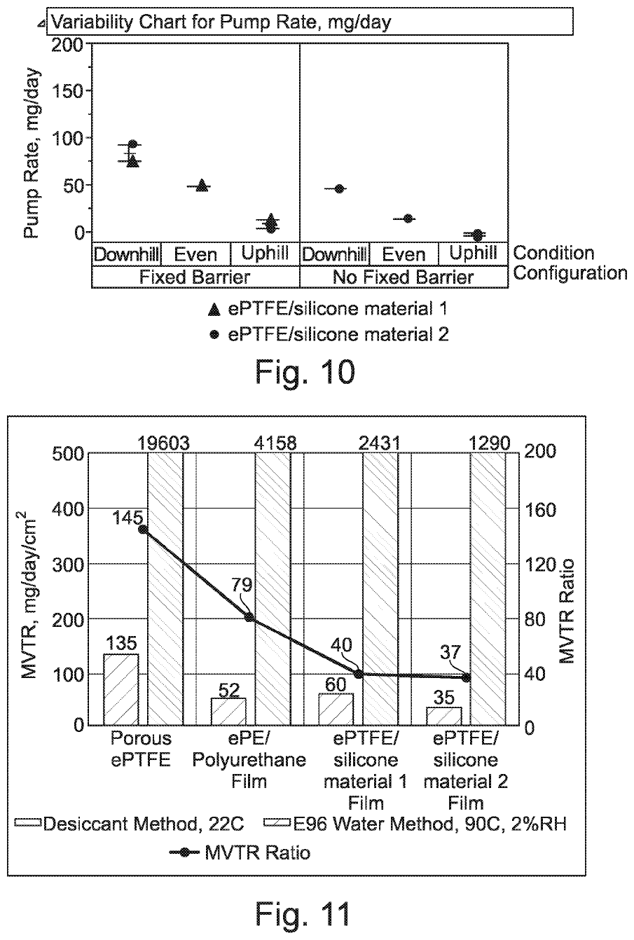

Average mass of water removed from the enclosure per day is plotted in FIG. 10, with the fixed barrier installed (data marked “Fixed Barrier”) and without the fixed barrier (data marked “No Fixed Barrier”). Also indicated in FIG. 10 are those data acquired using the ePTFE/silicone material 1 inner barrier, and those data acquired using the ePTFE/silicone material 2 inner barrier.

Both with and without the fixed outer barrier, “downhill” pumping from a 83% relative humidity enclosure to a 51% relative humidity laboratory was possible, however the device B including the fixed barrier was shown to be capable of pumping at approximately twice the rate of the device with the fixed barrier removed.

Rate of water removal by the device B from an enclosure at around ambient relative humidity (i.e. from a 56% relative humidity enclosure to a 51% relative humidity laboratory) was at a lower rate.

The device B was shown to be capable of removing moisture from the enclosure at 35% relative humidity, even where ambient humidity was higher. However, following removal of the fixed barrier, no such “uphill” pumping was possible. This illustrates the role of the fixed barrier.

### Example 4

Moisture vapour transmission rate data were acquired for a range of air-impermeable, water-vapour permeable materials.

In addition to the use of the bare porous ePTFE material, the ePTFE/silicone materials 1 and 2 described above, data were also acquired for the expanded ePE/polyurethane material.

### Method (a) Desiccant Method

A 10 g desiccant pack (MgCl₂/MgO desiccant in a non-woven PET pouch) was placed inside a glass canning jar (100 cm height, 7 cm diameter).

A steel lid was provided with a 2.62 cm² aperture (8.7×29.3 mm) and a sample of membrane material placed across the aperture and secured using silicone pressure sensitive adhesive. A corresponding aperture was provided in a steel blanking plate and the blanking plate placed over the membrane.

The jar was then sealed using the lid.

A control sample was prepared using an aluminium tape in place of the membrane.

The jar was placed in a climate-controlled laboratory at 22° C. and 50% relative humidity.

The mass of the jar was measured daily, and a linear regression was performed to obtain an MTVR. MVTR data was converted to mg/day/cm², measured relative to the control sample data.

### Method (b) High Temperature Water Desorption Method

A glass canning jar (100 cm height, 7 cm diameter) was filled with 100 ml distilled water. A polymer lid was provided with a 2.85 cm² circular aperture (19.05 mm diameter) and a sample of membrane material placed across the aperture and secured using silicone pressure sensitive adhesive.

The lid was also provided with a 1 mm diameter, 3 mm length polypropylene diffusion tube, with an ePTFE membrane vent cover secured over the diffusion tube outlet.

The jar was then sealed using the lid.

The jar was placed in an environmental chamber held at 90° C. and at each of 2% and 50% relative humidity.

The mass of the jar was measured daily, and a linear regression was performed to obtain an MTVR. MVTR data was converted to mg/day/cm².

A control sample was prepared using an unperforated lid.

### Method (c) E96 Water Method −25° C. and 45° C.

Experiments were also performed using the water test method described in section (b) above, with the jar placed into an environmental chamber held at 50% relative humidity (a Gintronic Gravitest 6300), and at each of 25° C. and 45° C. Air flow across the membranes was maintained as per the ASTM E96 standard.

### Results

MVTR results are set out in FIG. 11 and Table 1. MVTR ratio values were calculated from results performed using methods (a) and (b).

TABLE 1

| | | | | E96 Water | E96 Water | |
|---|---|---|---|---|---|---|
| | Desiccant | E96 Water | E96 Water | Method, | Method, | |
| | Method, | Method, | Method, | 90 C., | 90 C., | MVTR |
| Units in mg/day/cm² | 22 C. | 25 C. | 45 C. | 50% RH | 2% RH | Ratio |
| Porous ePTFE | 135 | 151 | 379 | 8824 | 19603 | 145 |
| ePE/Polyurethane Film | 52 | 93 | 207 | 2795 | 4158 | 79 |
| ePTFE/Silicone material 1 Film | 60 | No data | No data | No data | 2431 | 40 |
| ePTFE/Silicone material 2 Film | 35 | 35 | 97 | 712 | 1290 | 37 |

MVTR data for method (a) demonstrates the performance of membrane materials during adsorption conditions, which are typically of relatively long duration and where water vapour is required to permeate into a chamber at relatively low humidity.

MVTR data for method (b) demonstrates the performance of membrane materials during desorption conditions, which are typically of relatively short duration, high temperature and where water vapour is required to escape from the chamber at relatively high humidity.

For use in a device for removing moisture from an enclosure, a moisture barrier material must demonstrate a sufficiently high MTVR under both adsorption conditions and desorption conditions. However, he required MTVR under desorption conditions is lower than the required MVTR under adsorption conditions.

This is reflected in a lower MVTR ratio. The MVTR ratio data in Table 2 and FIG. 11 show that the ePE/polyurethane imbibed film, and the ePTFE/silicone materials 1 and 2 films all show a lower MVTR ratio than bare air-permeable, water vapour-permeable ePTFE.

MVTR data for method (c) demonstrate a range of materials that demonstrate suitable moisture vapour transport rates for use as a moisture barrier material in a device in accordance with the invention.

1. A device for removing moisture from within an enclosure associated with a heat source, the device comprising:
a housing defining a chamber; and desiccant material in the chamber;
a first part of the housing comprising a first port between the chamber and an environment outside of the housing;
a second part of the housing comprising a second port between the chamber and an environment outside of the housing;
the second port comprising:
a first barrier extending across the second port and comprising an air-impermeable water vapour-permeable moisture transport layer; wherein an outer side of the moisture transport layer is in fluid communication with the environment outside of the housing and an inner side of the moisture transport layer is in fluid communication with the chamber; and
a second barrier extending across the second port, wherein the second barrier is configured to conduct heat to the first barrier.

2. The device of claim 1, wherein:
the first barrier is an inner barrier and the second barrier is an outer barrier;
wherein an outer side of the moisture transport layer is in fluid communication with the environment outside of the housing and an inner side of the moisture transport layer is in fluid communication with the chamber; and
the outer barrier is adjacent the outer side of the moisture transport layer;
wherein the inner barrier is movable under the action of pressure changes within the chamber caused by heating the device, between a first position in which the inner barrier is spaced apart from the outer barrier and a second position in which at least a part of the outer side of the inner barrier contacts the outer barrier.

3. The device of claim 1, wherein the device comprises a heat source, operable to desorb at least some adsorbed water from the desiccant material.

4. (canceled)

5. An enclosure comprising a device for removing moisture from the enclosure, the device comprising:
a housing defining a chamber, and desiccant material in the chamber;
a first part of the housing comprising a first port providing fluid communication between the chamber and an environment outside of the enclosure;
a second part of the housing comprising a second port between the chamber and the enclosure;
the second port comprising: a first barrier extending across the second port and comprising an air-impermeable water vapour-permeable moisture transport layer; and a second barrier extending across the second port, wherein the second barrier is configured to conduct heat to the first barrier;
wherein the enclosure comprises or is associated with a heat source operable to increase the temperature of the device and desorb at least a part of the adsorbed water from the desiccant material; and to raise the temperature of the moisture transport layer to thereby reduce or eliminate condensation in the chamber.

6. The enclosure of claim 5, wherein the first barrier is an inner barrier and the second barrier is an outer barrier;
wherein an outer side of the moisture transport layer is in fluid communication with the enclosure and inner side of the moisture transport layer is in fluid communication with the chamber; and the outer barrier is adjacent the outer side of the moisture transport layer;
wherein the heat source is operable to increase the temperature of the device and to cause an increase of pressure within the chamber;
wherein the inner barrier is movable under the action of pressure changes within the chamber caused by heating the device using the heat source, between a first position in which the inner barrier is spaced apart from the outer barrier and a second position in which at least a part of the outer face of the inner barrier contacts the outer barrier.

7. The enclosure of claim 6, wherein the inner barrier comprises one or more lower permeability or impermeable regions impermeable to air or water vapour, the or each lower permeability or impermeable region being positioned so as to contact the outer barrier and occlude a fluid pathway through the outer barrier to the outer surface of the moisture transport layer, when the inner barrier is in the second position; and wherein when the inner barrier is in the first position, the or each lower permeability or impermeable region is spaced apart from the outer barrier and the device comprises a fluid pathway through or around the outer barrier to the outer surface of the moisture transport layer.

8. The enclosure of claim 6, wherein at least a part of the inner barrier is flexible and/or wherein the outer barrier is a fixed outer barrier.

9. (canceled)

10. The enclosure of claim 5, wherein the moisture transport layer comprises a porous support layer and an air-impermeable, water vapour-permeable material present in at least some of the pores of the support layer.

11. (canceled)

12. (canceled)

13. The enclosure of claim 10, wherein the support layer is elastically extendable.

14. (canceled)

15. The enclosure of claim 6, wherein the outer barrier comprises a bridge over or across the second port, wherein one or more fluid pathways are defined around the outer barrier and/or through the outer barrier.

16. The enclosure of claim 5, wherein first port has a smaller flow area and/or a longer flow path than the second port, such that permeation or diffusion of water vapour into the chamber via the second port exceeds the diffusion or flow of water vapour from the outside environment into the chamber via the first port.

17. (canceled)

18. A method of removing moisture from an enclosure, the method comprising:
during a first period:
transporting water vapour from the enclosure to a chamber via an air-impermeable, water vapour permeable moisture transport layer;
adsorbing at least a part of the water vapour onto desiccant material in the chamber; and
during a second period:
applying heat to:
raise the temperature of the desiccant material and desorb at least a part of the adsorbed water from the desiccant material;
raise the temperature of inside walls of the chamber and the moisture transport layer, to thereby reduce or eliminate condensation in the chamber; and
passing at least some of the water vapour from the chamber to an environment outside of the enclosure.

19. The method of claim 18, comprising moving an inner barrier comprising the moisture transport layer from a first position in which the inner barrier is spaced apart from an outer barrier, to a second position in which at least a part of an outer surface of the inner barrier contacts the outer barrier.

20. (canceled)

21. The method of claim 19, comprising raising the temperature of the moisture transport layer by moving the inner barrier into contact with the outer barrier during the second period, wherein the outer barrier is at a higher temperature than the moisture transport layer.

22. (canceled)

23. (canceled)

24. (canceled)

25. (canceled)

26. The device of claim 2, wherein the inner barrier comprises one or more lower permeability or impermeable regions impermeable to air or water vapour, the or each lower permeability or impermeable region being positioned so as to contact the outer barrier and occlude a fluid pathway through the outer barrier to the outer surface of the moisture transport layer, when the inner barrier is in the second position; and wherein when the inner barrier is in the first position, the or each lower permeability or impermeable region is spaced apart from the outer barrier and the device comprises a fluid pathway through or around the outer barrier to the outer surface of the moisture transport layer.

27. The device of claim 2, wherein at least a part of the inner barrier is flexible and/or wherein the outer barrier is a fixed outer barrier.

28. The device of claim 1, wherein the moisture transport layer comprises a porous support layer and an air-impermeable, water vapour-permeable material present in at least some of the pores of the support layer.

29. The device of claim 28, wherein the support layer is elastically extendable.

30. The device of claim 2, wherein the outer barrier comprises a bridge over or across the second port, wherein one or more fluid pathways are defined around the outer barrier and/or through the outer barrier.

31. The device of claim 1, wherein first port has a smaller flow area and/or a longer flow path than the second port, such that permeation or diffusion of water vapour into the chamber via the second port exceeds the diffusion or flow of water vapour from the outside environment into the chamber via the first port.
